(19) United States
(12) Patent Application Publication
(10) Pub. No.: US 2011/0080285 A1
(43) Pub. Date: Apr. 7, 2011

(54) DISTRESS BEACON AND DISTRESS ALARM SYSTEM

(76) Inventors: Philip Howson, Cornwall (GB); Gary Nigel Spengler, West Lancs (GB); William Robert Law, Cheshire (GB)

(21) Appl. No.: 12/900,300

(22) Filed: Oct. 7, 2010

(30) Foreign Application Priority Data
Feb. 29, 2008 (GB) GB 2458877

(51) Int. Cl. G08B 21/00; G01S 1/00

(52) U.S. Cl. 340/540; 342/385

(57) ABSTRACT

A distress beacon and associated detection system for water borne activities are disclosed. The beacon includes a signal transmitter, an antenna and an actuator arranged to activate the signal transmitter upon actuation, the signal transmitter being arranged, upon being activated, to periodically output a signal pulse via the antenna, the signal pulse including an identifier associated with the distress beacon

### FIELD OF THE INVENTION

The present invention relates to a distress beacon and remote receiver that are particularly applicable to water based activities such as surfing, open water swimming and the like.

### BACKGROUND TO THE INVENTION

High risk sports and activities such as surfing, open water swimming and the like require practice and experience in order to properly participate. However, it is often difficult for learners (and for that matter experienced participants) to judge the environment and decide whether the conditions are beyond their abilities.

The appeal and attraction of sports and activities such as these most likely derives from an unusual confluence of elements: adrenaline, skill, and high paced maneuvering are set against a naturally unpredictable backdrop—an organic environment that is, by turns, graceful and serene, violent and formidable.

As such these sports are inherently hazardous and unpredictable and accidents are common.

While it is often the case that beaches or lakes where such activities take place are normally supervised by qualified lifeguards/rescue teams, they are often far removed from the surfers/swimmers and only monitor the location visually.

In the case of swimmers and surfers, while performing patron surveillance, usually from an elevated stand or a water-level standing or sitting position, lifeguards watch for unusual activities on the part of swimmers to recognise struggling swimmers, drowning swimmers, and swimmers with sudden medical conditions such as stroke, heart attack, asthma, diabetes, or seizures. While performing patron surveillance, lifeguards try to prevent drowning or other injury and death by looking for swimmers in these categories such as:
Swimmers who are inactive in the water, submerged or otherwise (Passive drowning victim).
Swimmers who are taking in water while attempting to stay at the surface (Active drowning victim). Lifeguards look for swimmers in this condition by looking for arms flailing vertically, with the body vertical and no supporting kick. This behavior is known as the instinctive drowning response.
Swimmers who have become tired and are having trouble swimming (Distressed swimmer) and may or may not be calling out for help.

Identifying these situations, particularly if the victim is some distance from the shore, can be very difficult.

Distress beacons are known from applications such as shipping and sailing and are used to locate a “man overboard”. However, the challenges faced in swimming, surfing and other Water based leisure activities can be different to those in locating a man overboard. For example, it is common for a sailor to wear a lifevest or other flotation device to which the beacon may be incorporated or attached. This not only provides a suitable mount for the beacon, it also means that more time can be taken in homing in on the man overboard due to the fact that he is being assisted by the flotation device. Furthermore, such systems operate in isolation with a single receiver being used to detect a single active beacon. Extending such systems to multiple active beacons results in clashes and beacons competing for the same bandwidth.

In contrast, in sports such as surfing and swimming, hydrodynamics and streamlining are highly desirable and lifevests, flotation devices and the like are actively avoided as they would interfere with the performance of the sportsman or sportswoman. The lack of a buoyancy aid means that when a distress beacon is triggered, minimising time to detect and locate the beacon is desirable.

A further, related, issue with distress beacons is that transmission power will be adversely affected in applications such as surfing and swimming due to location of the beacon at the water's surface. Again, beacons that are attached to buoyancy devices commonly are not as severly affected by this issue due to elevation away from the water's surface.

Yet another issue is that a distress beacon may not be used for many months or years but the user must be comfortable that when it is finally triggered, it will still be functional.

### SUMMARY OF THE INVENTION

According to an aspect of the present invention, there is provided 1.A distress beacon for water borne activities including a signal transmitter, an antenna and an actuator arranged to activate the signal transmitter upon actuation, the signal transmitter being arranged, upon being activated, to periodically output a signal pulse via the antenna, the signal pulse including an identifier associated with the distress beacon.

The distress beacon may further comprise a housing accommodating the signal transmitter and antenna, at least part of the housing being arranged to disperse water any residual water film at the surface of the housing following splashing or submersion of the housing.

One or more parts of the housing may have properties selected from a group including:

water-repelling, water-attracting, texturing of external surface, grooving of external surface, slotting of external surface, dimpling of external surface.

Preferably, the housing is formed from plastics.

The distress beacon may further comprise a low power battery cell and a power conditioning circuit, the power conditioning circuit being arranged, upon activation of the distress beacon to supply a short duration power surge from power obtained from the low power battery cell to the signal transmitter.

The power conditioning circuit may include a charge pump and a storage capacitor, the charge pump being configured to charge the storage capacitor from power from the low power battery cell, the storage capacitor being configured to supply the short-duration power surge

The signal transmitter may be arranged to generate a radio frequency carrier wave and is arranged to control the carrier wave modulation to include the identifier

The signal transmitter may be further arranged to include data on the distress beacon state in the modulated carrier wave.

The actuator may be selected from a group including:

a depressible switch; a pull switch actuating a mechanical, electrical or magnetic actuator; a removable or frangible portion of a housing of the distress beacon, the distress beacon including a sensor arranged to detect ingress of water upon removal or breaking of the portion of the housing.

The distress beacon may comprise a plurality of actuators, each actuator independently or associatively being arranged to activate the signal transmitter.

The distress beacon may include a predetermined threshold, the distress beacon requiring a number of associated actuators to be actuated to activate the signal transmitter, the number being determined by said threshold.

The distress beacon may be arranged to encode data on at least the state of the actuator in the signal, the base station being arranged to generate said alarm in dependence on said encoded data.

According to another aspect of the present invention, there is provided a distress alarm system comprising a plurality of distress beacons and a base station:

each distress beacon including a signal transmitter and actuation means arranged to activate the signal transmitter upon actuation, the signal transmitter being arranged to output a signal including an identifier associated with the respective distress beacon upon being activated;

the base station including at least one directional antenna arranged to receive a signal from an activated distress beacon of the plurality of distress beacons for a plurality of different radiation patterns defined by said at least one antenna, wherein the base station further comprises processing means arranged to measure signal strengths of the received signals, to determine direction and range of the distress beacon in dependence on said signal strengths and to generate an alarm identifying said range and direction of said activated distress beacon.

The base station may be arranged to generate a different alarm for each of said activated distress beacon.

The distress alarm system may further comprise a data repository associating data on a user of the distress beacon with the respective identifier, wherein in generating said alarm, the base station is arranged to obtain data from said repository associated with the respective unique identifier and generate said alarm in dependence on said data.

The base station may comprise a plurality of fixed antennae, wherein the base station is arranged to determine direction of an activated distress beacon of the plurality of distress beacons in dependence on the received signal strength at each of the plurality of fixed antennae and the relative angle and directional characteristics between the antennae.

The base station may comprise a plurality of fixed antennae, wherein the base station is arranged to determine direction of an activated distress beacon of the plurality of distress beacons in dependence on the phase difference between the received signal strength at each of the plurality of fixed antennae.

The base station may be arranged to determine range of the activated distress beacon of the plurality of distress beacons in dependence on the measured received signal strength and transmission power of the signal transmitter of the respective activated distress beacon.

The distress beacon may be arranged to encode an indicator of transmission power within said signal.

The distress alarm system may further comprise a database recording last known transmission power of the distress beacon, the base station being arranged to estimate said transmission power in dependence on said data in said database.

In embodiments of the present invention, position (and therefore range) relative to one or more base stations can be determined through triangulation when there exist two or more base stations (which may use phase-difference or signal strength as the basis for their direction-finding) which are some distance apart. There may be a communication channel between base stations or alternatively, they may report to a central node. The different bearings respectively determined by each base station for an activated distress beacon are used to perform a triangulation calculation (in respect of each beacon that is active and for which a signal has been received). The calculation uses the data from the base stations along with predetermined data concerning the positions of base stations relative to each other. Where triangulation is performed by one or more of the base stations, data may be communicated therebetween via peer-to-peer communications where all units share their data or master-slave where slaves report to the master.

Embodiments of the present invention are particularly applicable for use by surfers. The most general basic desires for a surfing safety system are:
accurate and consistent direction-finding
adequate range
small beacon size

However, to be of benefit in the context of surfing, it is desirable that embodiments should also practically and reliably address and accommodate the more specific needs associated with surfing:

1. The system and its distress beacons and base-station receiver must be practical, simple and easy to use and maintain. Thus:

a). for the surfers, the distress beacons should:
be securely, practically, comfortably yet stylishly wearable
be easy to use with minimal instruction
require little care or maintenance yet be durable and reliable over a few years

b). for the lifeguards (or other responsible party) the receiving system should be quick, easy and simple to set up with a minimum of work or training

2. The receiving system will normally be monitoring a large number of users within its operating range and therefore it should be capable of registering the transmissions and determining the directions of several people simultaneously in difficulty, particularly as an event that may cause difficulty may indeed cause difficulty for a number of people at the same time. Thus stronger distress signals must not block reception of weaker distress signals, and mutual blocking of similar strength signals also has to be avoided.

3. The system should have good operating range despite important potential non-idealities: poor relative orientations of antennas, a limited height that the receiver antenna can practically be erected (while maintaining portability, ease of erection and mechanical stability), a direct signal path consequently for the most part close to a rough water surface, and a greater prevalence of interference at the shore than out at sea.

In preferred embodiments of the present invention, a distress beacon is integrated into a wrist-worn housing. Preferably, the distress beacon is able to transmit effectively as soon as possible after emergence from the water, and the receiver preferably is able to determine direction from a single transmission pulse. By being wrist-worn, when the arm is raised up a better height above the water is obtained than would be from a buoyancy aid; this is an aspect which partly offsets the more limited transmit power of the beacon compared with that of a larger, buoyancy-aid mounted transmitter.

### BRIEF DESCRIPTION OF THE DRAWING FIGURES

Embodiments of the present invention will now be described in detail, by way of example only, with reference to the accompanying drawings in which:

FIG. 1 is a schematic diagram of a distress alarm system according to an embodiment of the present invention;

FIG. 2 is a schematic diagram of a distress beacon according to a preferred embodiment of the present invention;

FIG. 3 is a schematic diagram of a base station 30 according to an embodiment of the present invention;

FIG. 4 is a schematic diagram of a directional antenna suitable for use in the base station of FIG. 3;

FIG. 5 is a polar plot of characteristics of the antenna of FIG. 4 showing received signal strength (in dBm) vs. direction;

FIG. 6 is a plot of an idealised response pattern in an embodiment of the present invention;

FIG. 7 is a schematic diagram illustrating a possible antenna configuration for use in an embodiment of the present invention; and,

FIG. 8 is a schematic diagram of a discrete LED display suitable for use in the base station of FIG. 3.

### DETAILED DESCRIPTION OF CERTAIN EMBODIMENTS OF THE INVENTION

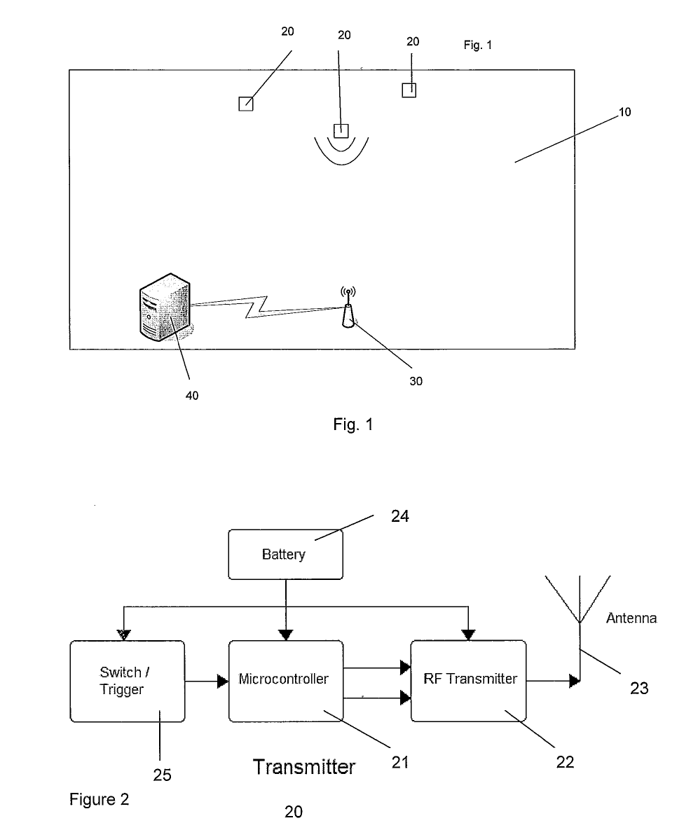

FIG. 1 is a schematic diagram of a distress alarm system according to an embodiment of the present invention.

The system 10 includes a distress beacon 20 to be worn by or otherwise carried by the user and a base station 30 to be located proximate to the monitoring personnel.

The distress beacon 20 is preferably a small, light-weight unit which can be easily attached to the user. Typically it would have an elasticated strap, and be worn around the wrist, ankle, etc. Any number of distress beacons 20 can be accommodated by a single base station 30.

In use, the base station (receiver) 30 is located at a fixed position, normally at a lifeguard station. A large beach may require more than one base station 30.

The distress beacon 20 includes a transmitter that is activated by the user in emergency situations either manually, by the user pressing a button, or automatically, by a suitable sensor e.g. depth sensor, accelerometer, etc. Preferably, the distress beacon 20 includes a unique identifier that is encoded within a distress signal that is transmitted when the transmitter is activated.

At the base station 30, the following preferably occurs as a result of the received distress signal:

An audible and/or visual alarm occurs

A graphical indication of the direction (bearing) of the user (optional)

A graphical indication of the distance (range) to the user (optional)

The base station 30 may optionally be arranged to communicate with a database system 40 holding data on users associated with the respective distress beacon 20. In this manner, data can be obtained from the database system 40 in the event of an alarm that identifies the user and/or his or her abilities, experience, medical issues etc in order to provide an enhanced (more informed) alarm at the base station 30. The data is stored in the database system against the unique identifier of the user's distress beacon. Therefore, when a distress signal is received, the data can be obtained in dependence on the identifier encoded within the signal.

FIG. 2 is a schematic diagram of a distress beacon according to a preferred embodiment of the present invention. The distress beacon 20 preferably includes:

A microcontroller containing control software/firmware 21;

A Radio Frequency transmitter 22;

An antenna tuned to the appropriate frequency 23;

A power source (e.g. watch battery) 24; and,

One or more switches/sensors/triggers 25.

When activated by the switch, trigger or sensor 25, the microcontroller 21 activates the Radio Frequency transmitter 22. The transmitter 22 generates an RF carrier wave. The microcontroller 21 software controls the carrier modulation such that the transmitted signal contains a code which uniquely identifies the distress beacon 20, and optionally contains other data (e.g. battery condition, alarm priority, sensor/switch/trigger type that activated the microcontroller). The modulated carrier wave is then transmitted via the antenna 23.

It is desirable that the distress beacon housing is slim and hydrodynamic, as well as small and wearable on an arm, leg or somewhere unobtrusive on the body of the user. The distress beacon is desirably low/no-maintenance, securely and durably watertight, and has a long pre-activation lifetime. Preferably, a sealed in battery is used as using replaceable batteries would compromise watertightness. In preferred embodiments, a single lithium-manganese dioxide coin cell is used. Such battery cells have shelf-lives of several years, and good energy capacity. However, such battery cells are limited in the power they can deliver.

For good radio operating range, the transmission power needs to be maximised, despite the transmitter antenna necessarily being small and inefficient due to limitations imposed by housing size.

In order to counterbalance both a limited power cell and inefficient antenna, a high-power circuit is preferably used in pulsed operation. Pseudorandomly pulsed transmission both permits detection of several simultaneously active transmitters by minimising collisions of transmissions and permits use of a cell with limited power delivery capacity. Transmission power is increased using a power conditioning circuit that uses a charge pump to step up the voltage and to steadily charge a storage capacitor which supplies the short-duration power surge required during each transmission pulse.

Preferably, the power cell is a limited power coin-type battery cell. A coin cell of this type has a continuous load in activation averaging 1.8-2.0 mA, peaking at 3.3 mA immediately after a transmission. The cell delivers continuous power averaging 5-6 mW (cell voltage is 2.6-3.0V, depending on load, temperature and state of depletion).

Given the necessarily small and consequently inefficient antenna, the radio circuit of the signal transmitter typically requires in the region of 200 mW in order to radiate at least 1mW radio signal power in the European 434 MHz band, as an example. This is also partly a consequence of accommodating other requirements that reduce efficiency: (1) adequately stable antenna tuning and (2) adequate suppression of radiation at harmonics of the intended frequency (—i.e. producing a substantially clean signal with very little distortion). Note that higher signal powers would be possible for higher frequencies (due to greater antenna efficiency that arises at higher frequencies), but other factors (propagation and receiver antenna considerations) would likely diminish any potential improvement in reception range.

Preferably, the distress beacon is approximately 35-40 mm wide and less or equal to 10 mm thick—broadly similar to the dimensions of a wristwatch.

Distress beacons according to embodiments of the present invention could be worn in many different ways such as on an armband, integrated into a wetsuit etc. In a preferred embodiment, a distress beacon includes a strap or band for wearing on a users's wrist. The advantage of wrist-wearing is that the distress beacon is raised higher above the water surface when the arm is raised.

To further enhance transmitter power by improving the stability of the tuning of its antenna, the distress beacon's housing is preferably water-repellent and/or textured or otherwise grooved, slotted or dimpled to rapidly shed, draw away and fragment any residual water film that results from splashing or submersion. This has the effect of reducing the effect of any capacitive or inductive coupling that would otherwise arise between the antenna and a surface-film of water. As an alternative or addition, selected areas of the beacon's housing may be made hydrophilic so as to encourage water dispersal.

Hydrophilic or hydrophobic properties may be introduced by coatings, appropriate selection of materials for the relevant parts of the housing or by inclusion of selected additives, plastics or compounds when moulding or forming the housing.

It is preferred that the housing is formed from plastics.

The distress beacon must not be activated simply by contact with water or immersion, as this is a routine aspect of surfing and swimming. The triggering of activation must therefore require a deliberate act by the user, such as pressing a switch, or pulling away some element such as a magnet (that holds the circuit in an off-state), or tearing away a pin or plug to allow ingress of water or cause an electrical contact to be made.

The mechanical element of the activation switch preferably incorporates a measure of mechanical resistance (after a small amount of travel, or otherwise) so as to prevent or deter unintended activation.

The mechanical element of the activation switch, once fully operated, remains in a different mechanical state relative to its unused state to indicate that the transmitter has already been activated and can no longer be used.

Given that the activation switch may be open for several years before it is closed, contact resistance could be a problem. A significant power loss could result for a direct connection of power. In order to avoid mechanical complications and compromise involved in maintaining the switch permanently closed with good contact once operated, the power switching at activation is preferably electronic. The mechanical element of the activation switch thus only needs to make a momentary electrical contact of indifferent quality in order to set the switching circuit into conducting state from a low-leakage off-state that can be maintained for many years without seriously depleting the battery.

A visual indication, such as a flashing low-power LED, is used in preferred embodiments to provide an assurance signal to the user that the beacon has been successfully activated and is operating in activated mode.

A small test switch may also be provided, in a position that makes it difficult to operate unintentionally or operate accidentally by hydrodynamic pressure, but which enables the user to confirm that the battery state remains good. A signal via a LED (or other means) is preferably used to indicate good or bad status. The test switch turns on the internal circuitry in a test mode whereby in a brief period the battery voltage is assessed, an indication is given and then the control circuit ceases to maintain the power switch circuit in its on-state thereby causing a return to the low-leakage off-state.

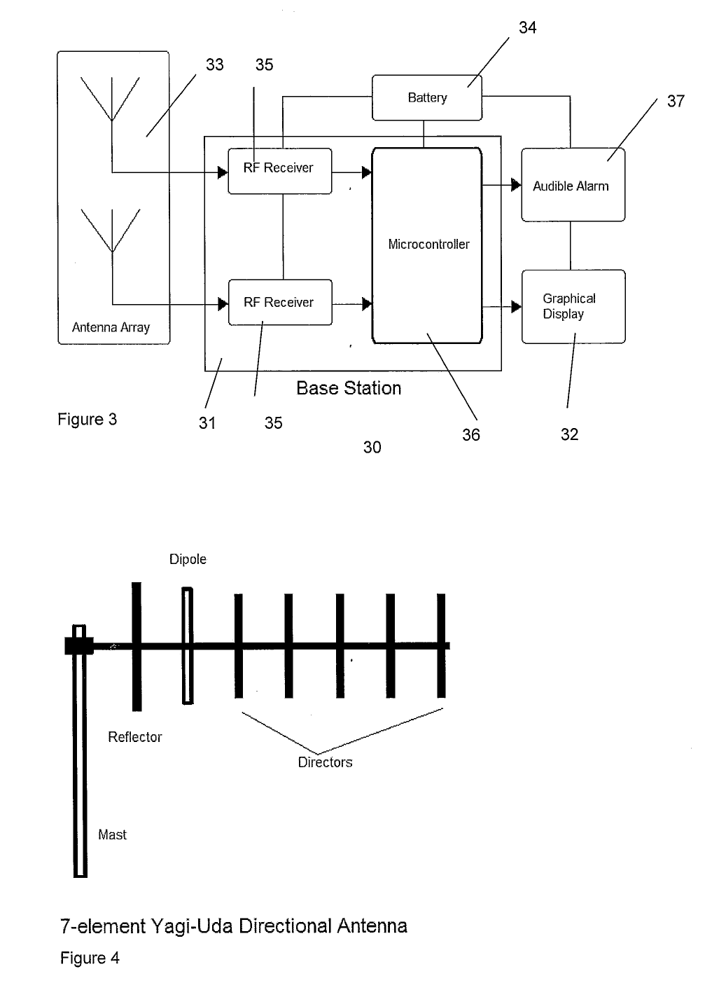

FIG. 3 is a schematic diagram of a base station 30 according to an embodiment of the present invention. The base station 30 preferably includes:

A Signal Processing Unit 31;

A Graphical Display Panel 32;

A Fixed Antenna Array 33;

A Power Source (e.g. battery) 34;

The Signal Processing Unit 31 is preferably a small unit housing the following electronics:

A number (at least two) of Radio Frequency receivers 35;

A microcontroller containing control software 36;

The display panel 32 could be built using a number of discrete indicators (e.g. LEDs), an LCD screen or laptop computer, or any other suitable device capable of showing a graphical display.

The antenna array 33 preferably comprises a plurality of directional antennae tuned to the frequency of the distress beacon(s) 20 and positioned so as to receive signals from different signal fields (although optionally there may be some overlap in signal fields).

In order to ensure accurate communication of the alarm signal with minimal chance of false alarms, a transmission protocol is preferably used. The modulation method and data structure used ensures maximum resilience to interference and avoid jamming.

In one embodiment this is done by using FSK (Frequency Shift Keying) as the modulation method. This is generally more robust than the common alternative, ASK (Amplitude Shift Keying). The data bits to be transmitted are grouped into 10-bit characters, and transmitted using an asynchronous serial protocol. A number of characters are typically grouped to form a packet, and error detection characters in the form of,a checksum is included. The number of characters in a packet would depend upon the amount of data which needs to be sent. Typically, one Start character, three ID characters, one Data character and two Checksum characters would suffice. This would allow a 24-bit identifier, resulting in over 16 million unique codes (2²⁴=16,777,216). The 8 bits of data could contain additional information, such as battery status. If more than one triggering mechanism (eg. based on different sensors or manual and sensor based) were implemented, the data could also indicate which trigger has operated.

In order to avoid jamming, the packet would need to be sent repeatedly, but at irregular intervals. The duty cycle would need to be low in order to accommodate many simultaneous transmissions. One way of achieving this is as follows: Assume the bit rate is 9600 bits/second. If the packet length is 70 bits (7 characters) this will take 7.3 ms to send. Divide time into 10 ms slots so that each slot can accommodate one packet, and allow say 100 slots to form one cycle. Now allocate the next packet to be sent to one slot number (1 to 100) chosen at random. When this slot occurs, send the packet and choose another slot number, again at random, for the next cycle. By this means the average packet repetition frequency is 1 packet/second, but there is only a 1% chance of another distress beacon choosing the same time slot, and therefore causing a potential jamming situation. Even if this does happen, it is 99.99% certain that the next packet will get through (1%×1%=0.01% chance of the next packet being jammed).

The function of the antenna array 33 is to receive signals from the distress beacon(s) 20, and pass them to the receiver 31. The direction of the distress beacon 20 can be deduced from the relative received signal strengths received at each of the plurality of antennae based on the relative angles and the directional characteristics of the antennae.

A common example of a suitable directional antenna is the Yagi-Uda configuration. This is a beam antenna, consisting of a dipole (the active element) closely coupled to a number of parasitic elements. FIG. 4 illustrates a typical arrangement with a ‘reflector’ behind the dipole, and a number of ‘directors’ in front. This antenna is directional along the axis perpendicular to the dipole in the plane of the elements. The assembly is supported by a mast positioned behind the reflector.

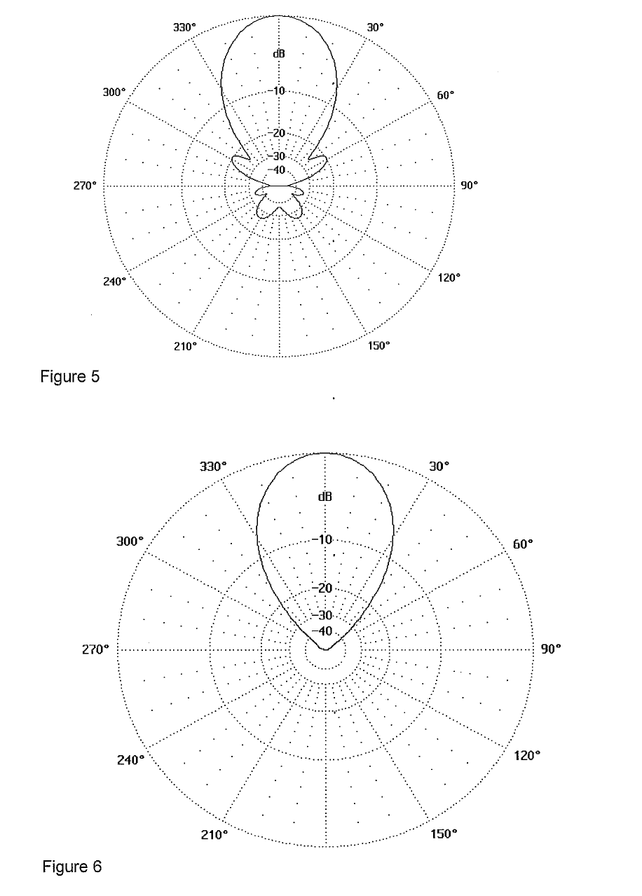

The directional characteristics of this type of antenna are illustrated in the polar plot of FIG. 5 showing received signal strength (in dBm) vs. direction.

Side lobes, which are characteristic of this configuration, are apparent at 300° and 60°. These are undesirable in this application, but by careful design of the antenna geometry (and in particular, size, shape and position of elements) these can be minimised, if not eliminated, to provide a more suitable response. The response behind the antenna also needs to be minimised. The plot of FIG. 6 shows an idealised response pattern.

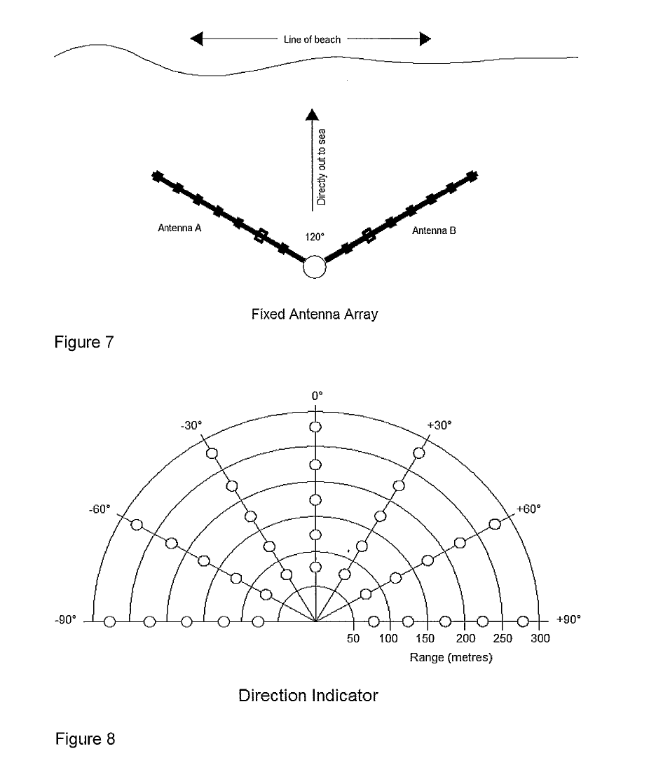

Considering an implementation using a fixed array of two antennae, the array is fixed to a single mast, and arranged such that the horizontal angle between each antenna and the common axis is approximately 60°, i.e. 120° between the antennae. The array would be positioned on the beach with the common axis pointing directly out to sea, i.e. at 90° to the line of the beach as illustrated in FIG. 7.

The distance between the distress beacon 20 and base station 30 is determined by measuring the received signal strength and comparing this to the transmitted power.

Environmental factors will cause reflections and signal absorption, which will impair the accuracy of both the direction and range measurements. However, approximate values are accurate enough for this application.

An example of a suitable discrete LED display is illustrated in FIG. 8. Depending on the number and position of lamps illuminated, the range and direction can be shown at the same time in an intuitive manner.

Alternatively, a graphic display panel could be used to provide a more detailed and aesthetically pleasing result.

An alternative to the antenna array 33 would be a single motor-driven directional antenna, which could be moved in a plane to scan the required area. This would require only one receiver in the Signal Processing Unit 31, and is potentially more accurate. However, this method would require more power (to drive the motor), which would be a disadvantage if the power source is a battery.

The motorized antenna would work by scanning the area of interest and decoding the received signals (if any) throughout the scan. The signal strength of any signals identified as coming from one of the distress beacons (there may be other signals on the same frequency that, for example, do not carry a properly encoded unique identifier which are ignored) are recorded along with the corresponding bearing (there will be many such pairs of data for each scan). At the end of a scan, the recorded data is analysed for peaks. The bearing(s) corresponding to peak(s) in signal strength indicate the direction of the distress beacon(s).

A third way of determining the direction and range would be to use the method of triangulation. This would require multiple base stations 30 (at least two). The range calculated by this method is potentially more accurate than the signal strength method, but it depends on the accuracy of the bearing determination.

The system may have other applications for outdoor distress alarm situations. The only restrictions are that communication follows line-of-sight, and the range is limited to 500 meters, or so. In a similar fashion, distress beacons may also be incorporated into articles to be worn by children or the like. These could be manually actuable such as discussed above or may be arranged to actuate when they pass into range of a particular signal generator (which may, for example, mark the end of a safe play area).

Alarm events could be logged to a suitable device (hard drive, memory stick, printer, etc.) or to the database system 40, together with their Distress beacon ID and time of occurrence.

The database system 40 could be maintained at the Lifeguard Station or remotely. This would enable patterns of use to be established, and would facilitate the identification of people who get into difficulty. Also, a level of competence could be associated with each ID, so that, for example, inexperienced people could easily be identified.

With regard to direction finding, an alternative method to comparing the RSSI output of angularly offset directional receiver antennas is to measure the signal phase difference between separate receiver antennas arising from the difference in their respective distances from the transmitter of the distress beacon. Using just two such antennas would yield two potential directions for the transmission, one of which could be discounted if, for example, the alignment of the antennas meant that it was an inland direction, while comparing the phases from three antennas would yield a single unique direction.

A requirement consequent from addressing the needs associated with surfing safety, is that the direction-finding must be able to work with a single short pulse and that the direction must be calculated with reasonable accuracy straightaway, rather than simply providing an indication adequate to allow ‘homing in’ on subsequent transmission from the same source through turning the antenna assembly: the receive antenna assembly is fixed for simplicity of setup and operation, and in any case needs to be able to deal with potentially a number of transmissions from different directions within a time-frame of less than a second. This could be achieved with the RSSI-based and phase-based systems by averaging (or weighted-averaging) the bearing obtained for the time of the duration of a pulse up to the point at which a transmission is decoded and thereby recognised as valid.

To better tolerate interference and low signal levels the phase-based direction finding subsystem uses a separate receiver front-end and mid-section for each antenna. Thus the chain of bandpass filter, low-noise amplifier, mixers and IF (intermediate frequency) filters and limiting amplifier are separate for each antenna, but the first local oscillator and (if used) second local oscillator are shared, providing a common phase reference. By this approach, and not using methods which involve partial cancellation of signals, the signal levels existing in the receiver circuitry are always maximised, both absolutely and with respect to interference.

Means are employed to remove phase shift changes arising within the separate receiver circuits due to the frequency-modulation of the received signals, such as using a form of phase-locked loop based demodulation to maintain the IF at a fixed frequency (by varying local oscillator frequency) to avoid varying phase shifts with frequency in the IF filtering. A further small, low-power, very low duty-cycle test signal can be fed into the receiver inputs or via the antennas from a small central transmit antenna within the antenna assembly to provide ongoing self-calibration of the phase-difference measurement.

If two or more receiver units are used and spaced some distance apart, a communication channel may be configured between them that is automatic or otherwise, such that the different directional bearings of the source of a distress signal registered by one of the respective units can be conveyed to the other to also determine the source's position and range through triangulation. This configuration may be in the form of peer-to-peer where all units share their data or master-slave where slaves report to the master.

1. A distress beacon for water borne activities, comprising:
a signal transmitter,
an antenna, and
an actuator arranged to activate the signal transmitter upon actuation,
wherein the signal transmitter is arranged, upon being activated, to periodically output a signal pulse via the antenna,
wherein the signal pulse includes an identifier associated with the distress beacon.

2. A distress beacon as in claim 1, further comprising a housing accommodating the signal transmitter and antenna, at least part of the housing being arranged to disperse water any residual water film at the surface of the housing following splashing or submersion of the housing.

3. A distress beacon as in claim 2, wherein one or more parts of the housing have properties selected from a group consisting of:
water-repelling, water-attracting, texturing of external surface, grooving of external surface, slotting of external surface, and dimpling of external surface.

4. A distress beacon as in claim 3, wherein the housing is formed from plastics.

5. A distress beacon as in claim 1, further comprising a low power battery cell and a power conditioning circuit, the power conditioning circuit being arranged, upon activation of the distress beacon, to supply a short duration power surge from power obtained from the low power battery cell to the signal transmitter.

6. A distress beacon as in claim 5, wherein the power conditioning circuit includes a charge pump and a storage capacitor, the charge pump being configured to charge the storage capacitor from power from the low power battery cell, the storage capacitor being configured to supply the short-duration power surge.

7. A distress beacon as in claim 1, wherein the signal transmitter is arranged to generate a radio frequency carrier wave and is arranged to control the carrier wave modulation to include the identifier

8. A distress beacon as in claim 7, wherein the signal transmitter is further arranged to include data on the distress beacon state in the modulated carrier wave.

9. A distress beacon as in claim 1, wherein the actuator is slected from a group consisting of:
a depressible switch; a pull switch actuating a mechanical, electrical or magnetic actuator; a removable or frangible portion of a housing of the distress beacon, and a sensor arranged to detect ingress of water upon removal or breaking of the portion of the housing.

10. A distress beacon as in claim 9, wherein the distress beacon comprises a plurality of actuators, each actuator independently or associatively being arranged to activate the signal transmitter.

11. A distress alarm beacon as in claim 10, wherein the distress beacon includes a predetermined threshold, the distress beacon requiring a number of associated actuators to be actuated to activate the signal transmitter, the number being determined by said threshold.

12. A distress beacon as in claim 10, wherein the distress beacon is arranged to encode data on at least the state of the actuator in the signal, the base station being arranged to generate said alarm in dependence on said encoded data.

13. A distress alarm system, comprising
a plurality of distress beacons and a base station,
each distress beacon including a signal transmitter and actuation means arranged to activate the signal transmitter upon actuation, wherein the signal transmitter is arranged to output a signal including an identifier associated with the respective distress beacon upon being activated;
the base station including at least one directional antenna arranged to receive a signal from an activated distress beacon of the plurality of distress beacons for a plurality of different radiation patterns defined by said at least one antenna, wherein the base station further comprises processing means for measuring signal strengths of the received signals, for determining direction and range of the distress beacon in dependence on said signal strengths and for generating an alarm identifying said range and direction of said activated distress beacon.

14. A distress alarm system as in claim 13, wherein the base station is arranged to generate a different alarm for each of said activated distress beacon.

15. A distress alarm system as in claim 14, further comprising a data repository associating data on a user of the distress beacon with the respective identifier, wherein, in generating said alarm, the base station is arranged to obtain data from said repository associated with the respective unique identifier and generate said alarm in dependence on said data.

16. A distress alarm system as in claim 13, wherein the base station comprises a plurality of fixed antennae, wherein the base station is arranged to determine direction of an activated distress beacon of the plurality of distress beacons in dependence on the received signal strength at each of the plurality of fixed antennae and the relative angle and directional characteristics between the antennae.

17. A distress alarm system as in claim 13, wherein the base station comprises a plurality of fixed antennae, wherein the base station is arranged to determine direction of an activated distress beacon of the plurality of distress beacons in dependence on the phase difference between the received signal strength at each of the plurality of fixed antennae.

18. A distress alarm system as in claim 13, wherein the base station is arranged to determine range of the activated distress beacon of the plurality of distress beacons in dependence on the measured received signal strength and transmission power of the signal transmitter of the respective activated distress beacon.

19. A distress alarm system as in claim 18, wherein the distress beacon is arranged to encode an indicator of transmission power within said signal.

20. A distress alarm system as in claim 13, further comprising a plurality of spaced apart base stations, the distress alarm system including data on the location of each base station, wherein the distress alarm system is arranged to triangulate location of an activated distress beacon in dependence on a signal received from the distress beacon at each of the plurality of base stations and on the location of the respective base station.
